(19) United States
(12) Patent Application Publication
(10) Pub. No.: US 2010/0125432 A1
(43) Pub. Date: May 20, 2010

(54) MEASUREMENT APPARATUS, MEASUREMENT METHOD, COMPUTER, PROGRAM, AND EXPOSURE APPARATUS

(75) Inventor: Ryo Sasaki, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/620,280

(22) Filed: Nov. 17, 2009

(30) Foreign Application Priority Data
Nov. 18, 2008 (JP) 2008-294536

(51) Int. Cl. G01B 11/14; G01B 9/02; G06F 15/00

(52) U.S. Cl. 702/150; 356/496

(57) ABSTRACT

A measurement apparatus includes an interferometer, and a computer configured to calculate a phase distribution and an amplitude distribution by Fourier-transforming a first interference signal detected by the photoelectric conversion element of the interferometer, to correct the phase distribution using a correction-use phase difference distribution, to calculate a second interference signal by reverse-Fourier-transforming the phase distribution that has been corrected and the amplitude distribution, and to calculate the position of the target surface based on the second interference signal.

### BACKGROUND OF THE INVENTION

1. Field of the Invention

The present invention relates to a measurement apparatus, a measurement method, a computer, a program, and an exposure apparatus.

2. Description of the Related Art

In an exposure apparatus, an optical sensor usually used for a focus detection system configured to detect a position of a substrate surface in a height direction is subject to the influence of reflections of a metallic layer under a resist on a substrate, and likely to erroneously measure a position of the metallic layer rather than a position of the resist surface. Accordingly, a recently proposed measurement apparatus measures a position of the substrate surface by using the white light interferometry. The white light interferometry enables the position of the substrate surface (resist surface) to be measured irrespective of the influence of the reflections of the metallic layer.

The white light interferometer splits a white light beam from a light source by a beam splitter, and guides one beam as measurement light to a surface to be measured (“target surface”) and the other beam as reference light to a reference surface, and synthesizes reflected beams from both surfaces using another beam splitter. As a result the measurement light transmits the beam splitter twice, whereas the reference light is reflected by the beam splitter twice. However, the detected white light interference signal distorts due to a difference between the reflection phase and the transmission phase, and another error of the optical system. Accordingly, as a solution for this problem, Japanese Patent Laid-Open No. (“JP”) 07-198318 discloses a method that improves the white light interference signal by equalizing optical path lengths between the long wavelength refractive index and the short wavelength refractive index of the transmission optical path of the beam splitter.

Other prior art include US Patent Application Publication No. 2007/0086013.

However, the method that corrects a difference of an optical path length between the transmission optical path and the reflection optical path disclosed in JP 07-198318 is arduous and may cause an increase of a manufacture cost and lower the yield.

### SUMMARY OF THE INVENTION

Accordingly, the present invention provides a measurement apparatus, a measurement method, a computer, a program, and an exposure apparatus, which can comparatively easily and precisely measure a position of a surface to be measured.

A measurement apparatus according to one aspect of the present invention configured to measure a position of a target surface to be measured includes an interferometer configured to split a broadband light beam from a light source, to guide as measurement light one beam of the broadband light beam to the target surface, to guide as reference light another beam of the broadband light beam to a reference surface, and to detect interference light formed by the measurement light and the reference light by utilizing a photoelectric conversion element, and a computer configured to calculate a phase distribution and an amplitude distribution by Fourier-transforming a first interference signal detected by the photoelectric conversion element, to correct the phase distribution using a correction-use phase difference distribution, to calculate a second interference signal by reverse-Fourier-transforming the phase distribution that has been corrected and the amplitude distribution, and to calculate the position of the target surface based on the second interference signal.

A measurement method according to another aspect of the present invention configured to measure a position of a target surface to be measured includes an interferometer splitting a broadband light beam from a light source, guiding as measurement light one beam of the broadband light beam to the target surface, guiding as reference light another beam of the broadband light beam to a reference surface, and detecting interference light formed by the measurement light and the reference light by utilizing a photoelectric conversion element, a computer calculating a phase distribution and an amplitude distribution by Fourier-transforming a first interference signal detected by the photoelectric conversion element, the computer correcting the phase distribution using a correction-use phase difference distribution, the computer calculating a second interference signal by reverse-Fourier-transforming the phase distribution that has been corrected and the amplitude distribution, and the computer calculating the position of the target surface based on the second interference signal.

A computer according to another aspect of the present invention includes a Fourier transformer configured to calculate a phase distribution and an amplitude distribution by Fourier-transforming a first interference signal detected by a photoelectric conversion element in an interferometer configured to split a broadband light beam from a light source, to guide as measurement light one beam of the broadband light beam to a target surface, to guide as reference light another beam of the broadband light beam to a reference surface, and to detect interference light formed by the measurement light and the reference light by utilizing the photoelectric conversion element, a corrector configured to correct the phase distribution using a correction-use phase difference distribution, a reverse Fourier transformer configured to calculate a second interference signal by reverse-Fourier-transforming the phase distribution that has been corrected and the amplitude distribution, and a calculator configured to calculate a position of the target surface based on the second interference signal.

A program according to another aspect of the present invention enables a computer to serve as the above means.

An exposure apparatus configured to expose an image of a pattern of an original onto a substrate includes a substrate stage configured to support and drive the substrate, the above measurement apparatus configured to measure a position of a surface of the substrate, and a controller configured to control driving of the substrate stage based on a measurement result of the measurement apparatus.

Further features of the present invention will become apparent from the following description of exemplary embodiments with reference to the attached drawings.

### BRIEF DESCRIPTION OF THE DRAWINGS

FIG. 1 is a block diagram of an exposure apparatus according to this embodiment.

FIG. 2 is a block diagram of a measurement apparatus applicable to the exposure apparatus shown in FIG. 1.

FIG. 3 is a graph for explaining a measurement error of the measurement apparatus shown in FIG. 2.

FIG. 4 is a diagram of a Fourier-transformed interference signal.

FIG. 5 is a graph showing a phase distribution of a Fourier-transformed interference signal.

FIG. 6 is a flowchart for explaining an operation of an operation processor shown in FIG. 2.

FIG. 7 is a flowchart for explaining details of S1300 shown in FIG. 6.

FIG. 8 is a graph for explaining a method of S1600 shown in FIG. 6.

FIG. 9 is a flowchart for explaining the way of using a result of S1600 shown in FIG. 6 for an exposure method.

FIG. 10 is a sectional view for explaining operations of S1710 and S1720 shown in FIG. 9.

FIG. 11 is a block diagram of another measurement apparatus applicable to the exposure apparatus shown in FIG. 1.

### DESCRIPTION OF THE EMBODIMENTS

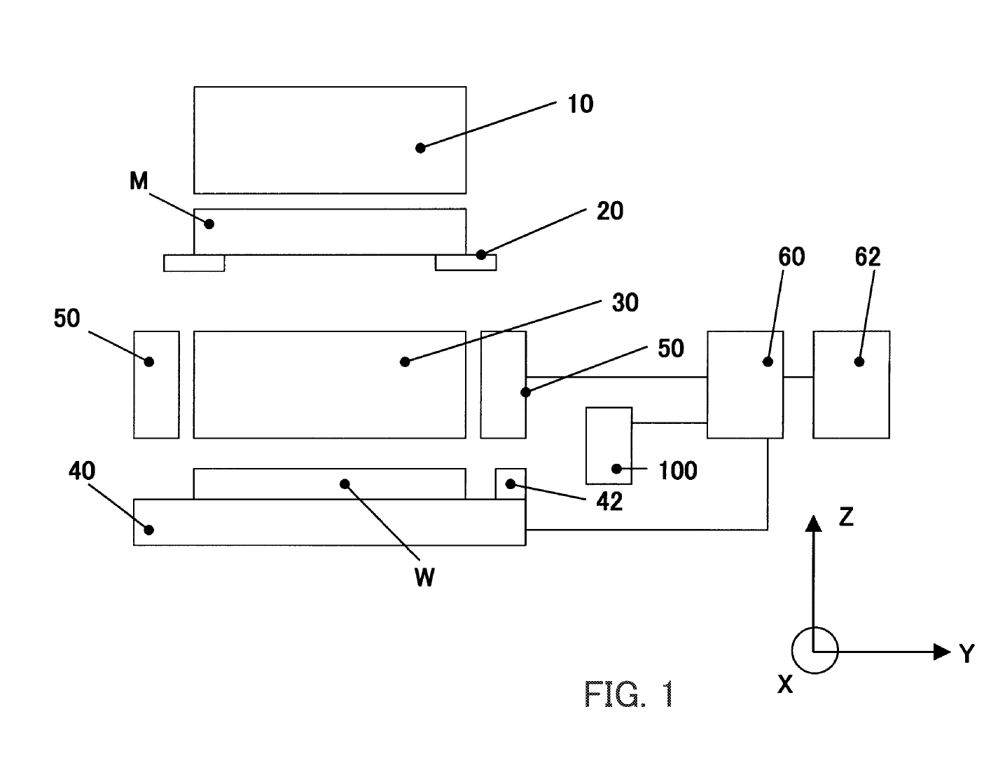

FIG. 1 is a block diagram of an exposure apparatus according to this embodiment. The exposure apparatus of this embodiment utilizes a step-and-scan method, but the present invention is applicable to a step-and-repeat exposure apparatus. In FIG. 1, a Y direction is a scanning direction, and an X direction is a non-scanning direction orthogonal to the scanning direction. A Z direction is a direction perpendicular to the XY plane, and parallel to the optical-axis direction of the projection optical system. In addition, a direction around the X direction will be referred to as a ωX direction, and a direction around the Y direction will be referred to as a ωY direction.

The exposure apparatus includes an illumination unit 10, an original stage 20, a projection optical system 30, a substrate stage 40, a focus detection system 50, a controller 60, and a measurement apparatus 100. The exposure apparatus is a projection exposure apparatus configured to expose an image of a pattern of an original M onto a substrate W via the projection optical system 30 by utilizing a light beam from a light source.

The illumination unit 10 serves to illuminate the original M, and includes a light source configured to emit a light beam for exposure, and an illumination optical system configured to uniformly illuminate the original M. The original M, such as a mask or a reticle, has a pattern to be exposed.

The original stage 20 supports the original M, and has a driving mechanism (not shown) configured to drive the original stage 20 at least in the Y direction that is the scanning direction.

The projection optical system 30 maintains the original M and the substrate W in an optically conjugate relationship, and projects the image of the original pattern onto the substrate W.

The substrate W is a wafer or a liquid crystal substrate onto which a photoresist is applied. The substrate W is an object to be measured, in which a position of its surface (target surface) in the Z direction is to be measured by the focus detection system 50 and a measurement apparatus 100.

The substrate stage 40 supports the substrate W, and drives it in each of the XYZ directions and in a direction around these directions. The substrate stage 40 is mounted with a reference plate 42. The reference plate 42 uses a glass plate having a good surface precision (referred to as an optical flat), and its surface has a uniform area having no reflectance distribution. The reference plate 42 may use part of a plate having a variety of calibration marks necessary for other calibrations of the exposure apparatus (for use with an alignment detector and an evaluation of the projection optical system).

The focus detection system 50 detects a position in the Z direction or the surface shape of the substrate W. The focus detection system 50 of this embodiment utilizes an optical sensor and has a structure different from that of the measurement apparatus 100. The focus detection system 50 illuminates a pattern utilizing the (obliquely incident) light from a light projecting unit, forms an image of the pattern onto the substrate W, and measures reflected light from the substrate W utilizing a light receiving unit, such as a CCD. The focus detection system 50 may use an air gauge, a capacitance gauge, a proximity probe instead of an optical sensor.

The controller 60 controls each component in the exposure apparatus, and provides a focus control by controlling driving of the substrate stage 40 based on the detection result by the focus detection system 50. In addition, the controller 60 calibrates a detection result of the focus detection system 50 based on a measurement result of the measurement apparatus 100. The controller 60 is connected to a memory 62.

The measurement apparatus 100 measures a surface shape or a position in the Z direction, an average height of a predetermined area within the XY plane, and an average inclination information (cox, coy) of the (target) surface of the substrate W (an object to be measured or “target object”). When the substrate W has a plurality of thin films, the measurement apparatus 100 measures one of the uppermost thin film surface, an interface of each thin film, and height information of the substrate itself.

Thus, although both the focus detection system 50 and the measurement apparatus 100 measure the surface position of the substrate W, the focus detection system 50 has a better responsiveness and the measurement apparatus 100 is less likely to be cheated by the pattern.

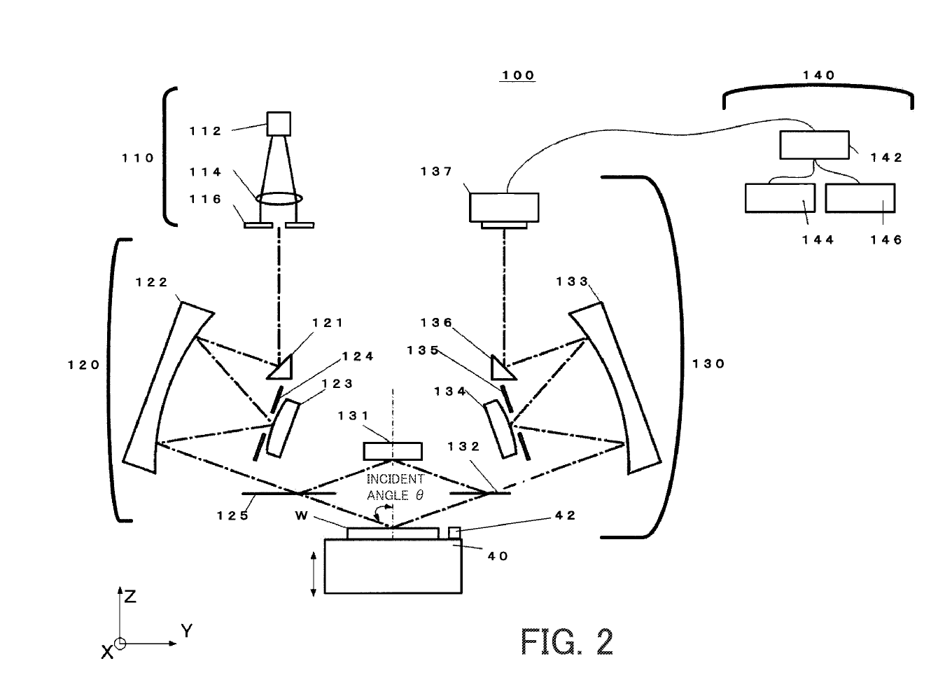

FIG. 2 is an optical-path diagram of the measurement apparatus 100. The measurement apparatus 100 includes an illumination unit 110, a light projecting optical system 120, a stage system, a light receiving optical system 130, and a data processing system 140. The illumination unit 110, the light projecting optical system 120, the stage system, and the light receiving optical system 130 constitute an interferometer, and the data processing system 140 can be implemented as a computer.

The illumination unit 110 includes a light source 112 and an illumination optical system.

The light source 112 may use an LED (including a so-called white LED) configured to emit light having a broadband wavelength width or a halogen lamp, and may also use a plurality of lasers having a narrowband wavelength region. The wavelength region of the light source 112 may be, but is not limited to, a region between 400 nm and 800 nm, and may have a band of 100 nm or higher. When the resist is formed on the substrate W, the wavelength region may be 350 nm or higher so as to prevent exposure of the resist. The polarization state of the light is set to a non-polarization state or circularly polarized state.

The illumination optical system includes a condenser lens 114 configured to condense the generated light, and a slit plate 116 configured to illuminate the measurement light to the substrate W. The slit plate 116 has a rectangular transmission area (slit) having a slit width of 50 μm and a length of 700 μm (X direction). The transmission area is not limited to a rectangular, and may be formed as a circle or a pinhole. The size of the slit may be varied in accordance with the measurement area of the substrate W. The slit is not limited to the transmission area, and the metallic plate may be provided with a light transmission area having a slit shape.

The light projecting optical system 120 includes a prism type mirror 121 configured to deflect a light beam, a concave mirror 122, a convex mirror 123, an aperture stop 124, and a beam splitter 125 configured to split the light beam.

When there is a sufficient space for the illumination optical system, the prism mirror 121 may be omitted.

The concave mirror 122 and the convex mirror 123 may form a so-called Ophner type arrangement relationship in which each center of curvature has a relationship of a concentric circle. Moreover, the curvature of the concave mirror 122 (R concave) and the curvature of the convex mirror 123 (R convex) may have a relationship of R convex=R concave/2, and each center of curvature may have a non-concentric circle.

The aperture stop 124 may be omitted by limiting the reflection area of the concave mirror 123 by utilizing the reflective film.

The beam splitter 125 splits the light beam from the concave mirror 122. The beam splitter 125 transmits as measurement light one of split light beam (having almost half a light quantity) and guides the measurement light to the target surface on the substrate W, and reflects as reference light another of split light beam (having almost half a light quantity) to a reference surface of a reference mirror 131. The incident angles of the light beams onto the substrate W and the reference mirror 131 are equal as θ to each other. As the incident angle θ increases, the reflectance from the thin film surface on the substrate becomes stronger than the reflectance of the back surface of the thin film, and thus a large incident angle θ is suitable for a measurement of the surface shape of the thin film. On the other hand, when the incident angle θ is close to 90°, an assembly of the optical system becomes difficult. Thus, the incident angle θ may be set to a range from 70° and 85°.

This embodiment uses a pellicle type beam splitter that includes a thin film (made of SiC or SiN) which has a thickness of about 1 μm to about 5 μm.

The stage system has a substrate stage 40 configured to drive the substrate W and a wafer chuck (not shown) that is configured to hold the wafer W. The position of the substrate stage 40 can be measured by utilizing a laser interferometer (not shown).

The light receiving optical system 130 includes a reference mirror 131, a beam splitter 132, a concave mirror 133, a convex mirror 134, an aperture stop 135, a prism type mirror 136, and a photoelectric conversion element 137.

The reference mirror 131 may use an aluminum plane mirror having a surface precision of about 10 nm to about 20 nm, a glass plane mirror having a similar surface precision, or the like.

The beam splitter 132 synthesizes the measurement light that has entered the (target) surface of the substrate W and been reflected on that target surface with the reference light that has entered the reference surface of the reference mirror 131 and been reflected on that reference surface. This embodiment utilizes for the beam splitter 132 a pellicle type beam splitter that includes a thin film (made of SiC or SiN) which has a thickness of about 1 μm to about 5 μm. The beam splitters 125 and 132 use the same thickness and material, and make the incident angles of the light beams equal to each other. The beam splitters 125 and 132 may use a prism type beam splitter in which a film such as a metallic film and a dielectric multilayer film is used for a split film, instead of the pellicle type beam splitter.

The concave mirror 133 and the convex mirror 134 form a bilateral telecentric imaging optical system, and form an image of the surface of the substrate W onto the light receiving plane of the photoelectric conversion element 137. The arrangement between the concave mirror 133 and the convex mirror 134 may be set similar to the arrangement between the concave mirror 122 and the convex mirror 123.

The aperture stop 135 is arranged at a pupil position of the imaging optical system that includes the concave mirror 133 and the convex mirror 134, and narrows the numerical aperture (“NA”) of the imaging optical system to a very small NA of about sin(0.1°) to about sin(5°). The aperture stop 135 may be omitted by limiting the reflection area of the concave mirror 134 using the reflective film, etc.

The prism type mirror 136 is a beam deflector configured to deflect the direction of the light beam. When there is a sufficient space to form the photoelectric conversion element 137, the prism type mirror 136 may be omitted.

The photoelectric conversion element 137 detects the interference light that is formed by the measurement light and the reference light. The photoelectric conversion element 137 includes a light quantity detection element, such as a photodetector, a one-dimensional line sensor (such as a photodetector array, a CCD line sensor, and a CMOS line sensor), and a two-dimensional sensor (such as a two-dimensional CCD and a two-dimensional CMOS). When the one-dimensional sensor or the two-dimensional sensor is used, a measurement area on the substrate W that can be detected by one measurement increases and the measurement time becomes shortened.

The data processing system 140 includes an operation processor 142, a memory 144 configured to store data, and a display 146 configured to display a measurement result and a measurement condition. The operation processor 142 outputs the processing result to the controller 60.

In operation of the measurement apparatus 100, the light from the light source 112 is condensed by the condenser lens 114 around the transmission area (slit) of the slit plate 116, and the light projecting optical system 120 forms an image of the slit onto the substrate W and the reference mirror 131. The light having almost half a light quantity of the light that passes the light projecting optical system 120 transmits the beam splitter 125, and enters the substrate W with a principal ray of the incident angle θ. The light having almost half a light quantity of the light is reflected on the beam splitter 125 and enters the reference mirror 131 with the same incident angle θ as that for the substrate W.

The light reflected on the substrate W and the light reflected on the reference mirror 131 are incident upon the beam splitter 132, and synthesized by the beam splitter 132. The images of the slit formed on the substrate W and the reference mirror 131 are re-formed on the light receiving plane of the photoelectric conversion element 137 by the concave mirror 133 and the convex mirror 134. On the light receiving plane of the photoelectric conversion element 137, the measurement light and the reference light overlap each other and form the interference of the light (interference light).

In order for the photoelectric conversion element 137 to obtain the white light interference signal, the substrate stage 40 is driven in the Z direction. In changing the measurement area of the substrate W, the above measurement is performed after the substrate stage 40 is driven in the X direction or Y direction and the predetermined area is aligned with or located on the light receiving area of the photoelectric conversion element 137.

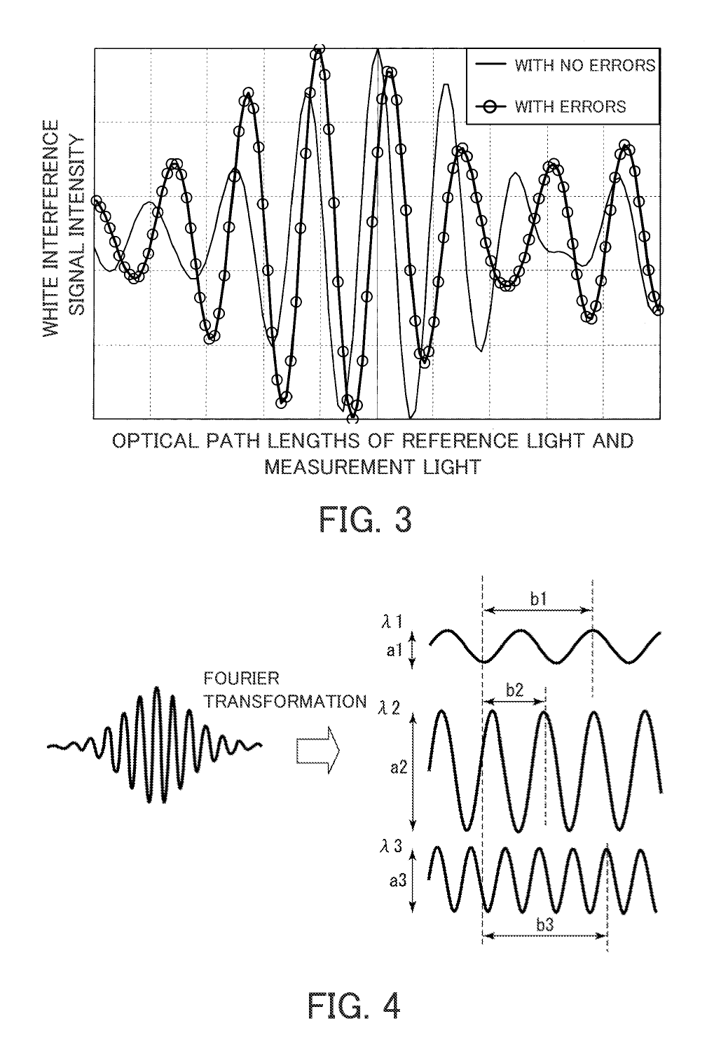

In the beam splitter, a phase difference occurs between the transmitted light and the reflected light due to the characteristic of the semipermeable membrane. Thus, the measurement light that has transmitted the beam splitters 125 and 132 is different in phase for each wavelength from the reference light that are reflected on the beam splitters 125 and 132. The waveform of the white light interference signal output from the photoelectric conversion element 137 distorts as shown in FIG. 3. The distortion of the white light interference signal is caused not only by the beam splitter but also by the assembly error of each component in the measurement apparatus 100. For example, when the angle of the beam splitter 125 or 132 to the incident light shifts from the design value in the assembly, a phase shift amount varies between the measurement light and the reference light. In addition, a phase of the reference light varies and the white light interference signal distorts, when the installation angle of the reference mirror 131 shifts or another material adheres to or alters on the surface of the reference mirror 131, or a reflective film different from the design value is formed.

The white light interference signal (interferogram) is a sum of the light interference intensities for each wavelength (frequency) of the white light. Accordingly, when the white light interference signal is Fourier-transformed (more strictly complex-Fourier-transformed), information of the amplitude and the phase can be obtained at the frequency corresponding to each wavelength. Here, the phase distribution having a frequency as a variable (frequency dependency of the phase) depends upon the phase variance for each wavelength of the optical system, the phase variance etc. for each wavelength of the target surface.

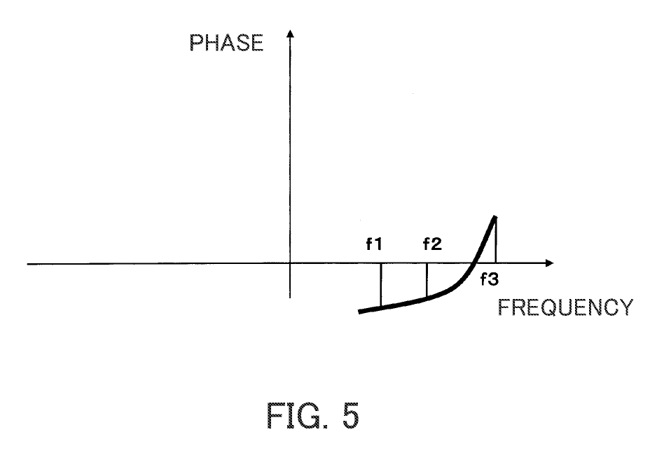

For example, the components of wavelengths λ1, λ2, and λ3 of Fourier-transformed white light interference signal shown on the left side in FIG. 4 becomes as shown on the right side in FIG. 4. Amplitude a1, a2, and a3 are those calculated from a real part and an imaginary part of the result of the Fourier-transformed white light interference signal, and proportional to the size of the amplitude of the corresponding frequencies f1, f2, and f3. FIG. 5 is a graph showing a phase distribution of a resultant Fourier-transformed white light interference signal. The frequencies f1, f2, and f3 correspond to the wavelengths λ1, λ2, and λ3, respectively, in FIG. 4, and phases of the frequencies f1, f2, and f3 correspond to the phases b1, b2, and b3 shown in FIG. 4.

In this application, the term “white light” has the same meaning as the “broadband light,” because the broadband light having the wavelength region (such as 500 nm to 800 nm) that does not use blue light provides similar effects. In addition, the broadband light can be defined as the light that contains a plurality of wavelengths (or frequencies) that are separable by the signal processing by the computer.

This embodiment maintains the amplitude as a result of the Fourier transformation, corrects a phase shift relative to the frequency, which occurs due to a manufacture error and an assembly error, then performs a reverse Fourier transformation, and obtains a high-contrast white light interference signal. Since this embodiment corrects a phase of the signal waveform instead of correcting the optical system of the interferometer itself, a position of the target surface can be comparatively easily and highly precisely measured.

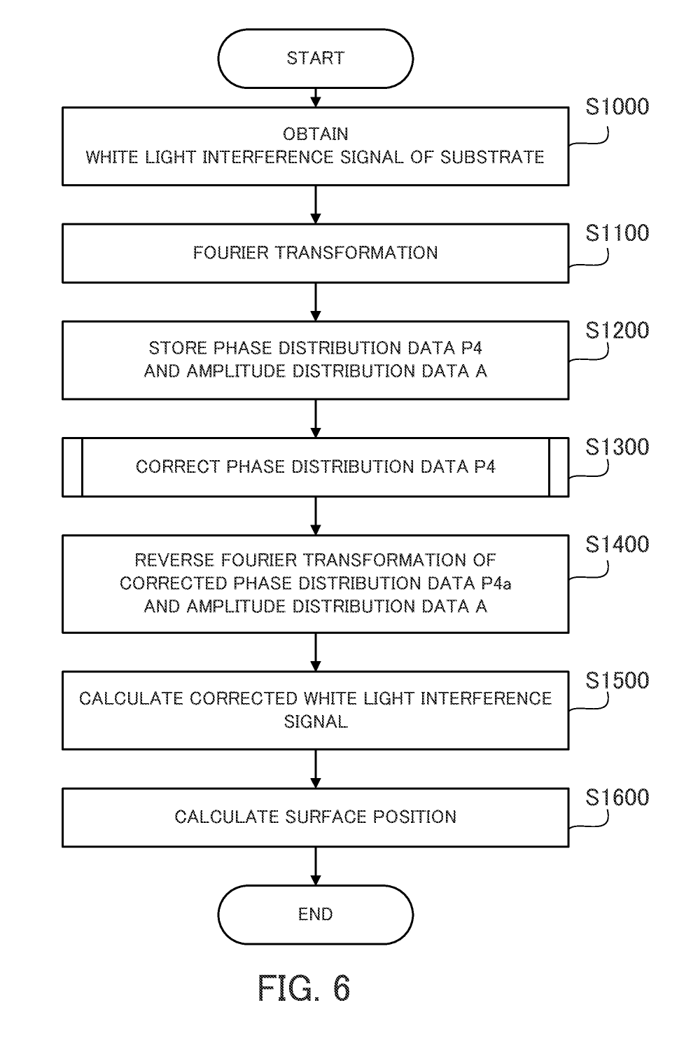

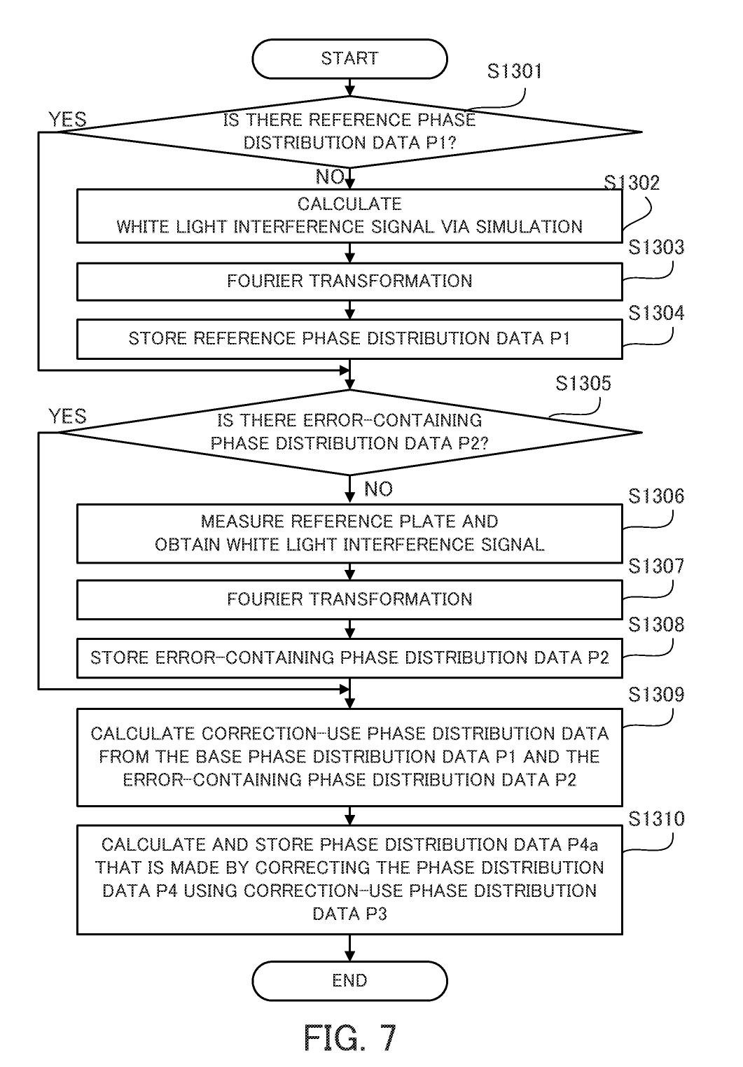

FIGS. 6 and 7 are flowchart for explaining a process by the data processing system 140. In FIGS. 6 and 7, “S” is an abbreviation of the step. The memory 144 stores the flowchart shown in FIG. 6 as a program (software).

Initially, the substrate stage 40 is driven in the Z direction, and the photoelectric conversion element 137 detects the white light interference signal (first interference signal) (S1000). Next, the operation processor 142 Fourier-transforms the white light interference signal (or first interference signal) (S1100), calculates phase distribution P4 and amplitude distribution (intensity) data A, and stores them in the memory 144 (S1200).

Next, the operation processor 142 generates phase distribution data P4a in which the phase distribution data P4 is corrected and the error of the optical system of the interferometer is removed (or which contains no errors) (S1300).

FIG. 7 is a flowchart showing details of S1300.

Initially, the operation processor 142 determines whether there is previously held reference phase distribution data P1 (S1301). The reference phase distribution data P1 indicates an ideal phase that has no error and is obtained when the measurement, calculation or simulation is performed for the predetermined target surface.

When it is determined that there is no reference phase distribution data P1 held (No of S1301), the operation processor 142 performs a simulation with design values such as a spectral characteristic of the light source 112, the spectral characteristic of the optical system, and the wavefront aberration, etc., which are actually measured, and calculates the white light interference signal (S1302). Here, the simulation that uses the refractive index and the absorption coefficient by setting the reference plate 42 to an object to be measured. This configuration provides a white light interference signal that is not subject to the influence of the manufacture error or the assembly error of the optical system in the interferometer. In addition, instead of using the actually measured value, a nominal value or a design value may be used for the spectral characteristic of the light source 112.

Next, the operation processor 142 performs a Fourier transformation for this white light interference signal (S1303) and stores, as reference phase distribution data P1, the phase obtained by the Fourier transformation in the memory 144 (S1304).

When it is determined that there is previously held phase distribution data P1 (Yes of S1301), or that the process of S1304 is performed, the operation processor 142 determines whether there is held error-containing phase distribution data P2 (S1305). The error of the error-containing phase distribution data P2 is an error of the optical system of the interferometer.

When it is determined that no error-containing phase distribution data P2 is held in S1305 (No of S1305), the operation processor 142 drives the reference plate 42 in the Z direction, obtains the white light interference signal through the actual measurement, and stores it in the memory 144 (S1306). Thus, S1304 and S1308 utilize the interference signal obtained with the reference plate 42 that is the same target object.

Next, the operation processor 142 Fourier-transforms the obtained white light interference signal (S1307), stores the phase component as the error-containing phase distribution data P2 in the memory 144 (S1308).

When there is previously held error-containing phase distribution data P2 (Yes of S1305) or when the process of S1308 is performed, the operation processor 142 subtracts the reference phase distribution data P1 from the error-containing phase distribution data P2 for each wavelength. Thereby, the operation processor 142 calculates correction-use phase distribution data P3 representative of an error of the optical system in the interferometer (S1309). In S1309, the operation processor 142 subtracts the phase distribution data P1 that has no manufacture error or assembly error from the phase distribution data P2 that contains a manufacture error and an assembly error, and calculates a phase shift component (correction-use phase distribution data P3) that occurs through the manufacture error and the assembly error.

The previously calculated correction-use phase distribution data P3 may be stored in the memory 144, and S1309 may be omitted. At this time, when the spectral characteristic of the optical system including the light source or the reflection characteristic relative to the wavelength of the reference plate 42 changes, the correction-use phase distribution data P3 may be re-calculated and the correction-use phase distribution data P3 that has been stored in the memory 144 may be updated.

Next, the operation processor 142 calculates phase distribution data P4a that is corrected by subtracting the correction-use phase distribution data P3 from the phase distribution data P4 (S1310). The phase distribution data P4 is phase distribution data obtained by Fourier-transforming the white light interference signal measured for the substrate W, and represents a phase that contains the influence of the manufacture error and assembly error of the measurement apparatus 100. The operation processor 142 calculates the corrected phase distribution data P4a in which the manufacture error and assembly error are eliminated, by subtracting the correction-use phase distribution data P3 from the phase distribution data P4.

Where physical property values of the substrate, such as a refractive index and an absorption coefficient, to be measured by S1306 are known, the simulation of the substrate may be performed at S1302 and the white light interference signal may be obtained for the substrate at S1306. The simulation without a wavefront aberration of the optical system at S1302 can also correct a deterioration of the white light interference signal caused by the design value at S1309. In addition, at S1302, a plurality of measurement apparatuses 100 is produced and the average of the white light interference signals may be used instead of the simulated white light interference signal.

Thereafter, the operation processor 142 performs the reverse Fourier transformation for the corrected phase distribution data P4a and the amplitude distribution data A (S1400), and calculates the corrected white light interference signal (second interference signal) (S1500). Thereby, even when the measurement apparatus 100 has a manufacture error or an assembly error, a white light interference signal in which a distortion is reduced can be obtained and a surface shape can be highly precisely detected.

Finally, the operation processor 142 calculates a position in the Z direction of the target surface that is a surface of the substrate W based on the corrected white light interference signal (second interference signal), and obtains the surface shape of the substrate W (S1600).

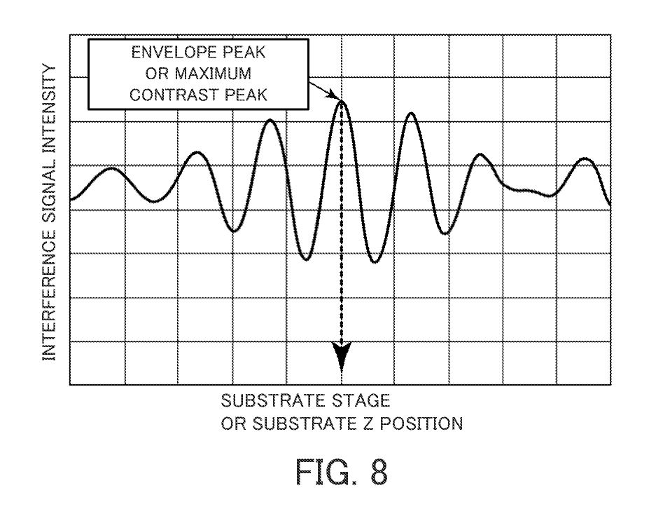

FIG. 8 is a graph of the white light interference signal. The abscissa axis denotes a position of the substrate stage 40 in the Z direction, and the ordinate axis denotes an intensity of the white light interference signal that is an output of the photosensitive conversion element 137. The position of the substrate stage 40 in the Z direction is measured by a Z-axis length measurement interferometer (not shown) although the length measurement sensor may use an electrostatic capacitance sensor. The operation processor 142 calculates a signal peak position of the white light interference signal, and the corresponding Z position is the height position in the detection area. When the photosensitive conversion element 137 uses a two-dimensional sensor, a three-dimensional shape of the substrate W can be measured.

More specifically, the surface position of the substrate W is detected by detecting a peak of an envelope of the white light interference signal or the maximum contrast of the interference signal. A signal intensity peak, a center of gravity calculation or function fitting using a quadratic approximation is performed for an interference pattern (referred to as a “central fringe” hereinafter) at the center of the white light interference signal. Thereby, the peak of the central fringe can be detected and the surface position of the substrate W can be detected. Moreover, by performing moving average or function fitting for the measurement value of the white light interference signal, the surface position of the substrate W can be detected with a resolution of about 1/10 to 1/50 as long as the sampling pitch Zp in the Z direction as the abscissa axis shown in FIG. 8. The sampling pitch Zp may be driven stepwise at regular intervals. In addition, the measurement time can be shortened by obtaining an output (Z position) of the Z-axis length measurement interferometer in synchronization with the capturing timing of the photoelectric conversion element 137 by setting the velocity of the Z stage to Zsp and by driving the Z stage at the uniform rate.

The operation processor 142 calculates the entire substrate surface shape by performing the processing shown in FIG. 6 at each position on the XY plane on the substrate W, stores the shape data in the memory 144, or enables the shape data to be displayed on the display 146.

While this embodiment fixes the reference mirror 131 and moves the substrate W, the substrate W may be fixed and the reference mirror 131 may be moved in the Z direction. Moreover, without driving the substrate W or the reference mirror 131, a spectral element may be arranged in front of the light receiving sensor and the interference intensity may be detected on the sensor for each wavelength, as disclosed in US Patent Application Publication No. 2007/0086013.

In exposure, the measurement apparatus 100 measures the surface shape of the substrate W, and the controller 60 controls driving of the substrate stage 40 based on the measurement result of the measurement apparatus 100.

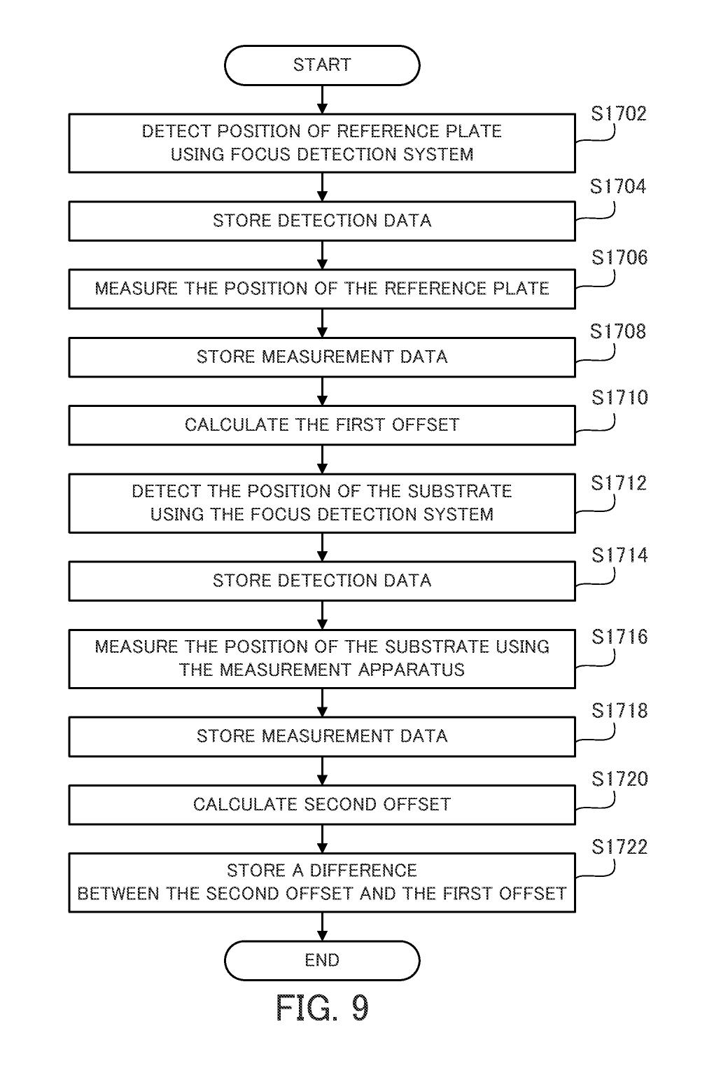

More specifically, the detection result of the focus detection system 50 may be calibrated by the measurement result of the measurement apparatus 100. FIG. 9 is a flowchart for explaining the calibration method.

Initially, the controller 60 detects the position of the substrate plate 42 in the Z direction using the focus detection system 50 (S1702), and stores a detection value Om in the memory 62 (S1704). Next, the controller 60 uses the measurement apparatus 100 and measures the same position as the detection object position of the focus detection system 50 with respect to the XY plane (S1706), and stores a measurement value Pm in the memory 62 (S1708).

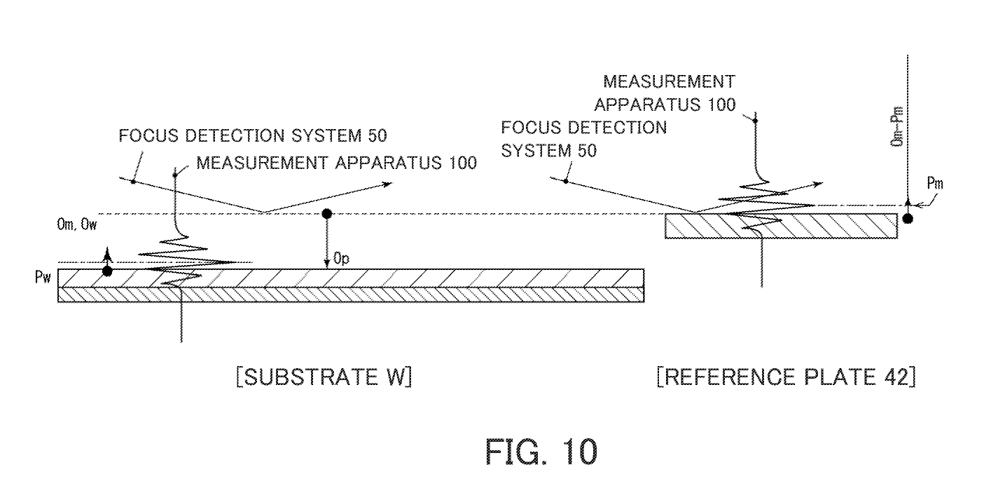

Next, the controller 60 calculates a first offset that is a difference between the measurement value Pm of the measurement apparatus 100 and the detection value Om of the focus detection system 50, as shown in FIG. 10 (S1710). The first offset needs to be originally zero but occurs due to the error factors, such as the offset of the substrate stage 40 in the scanning direction and the long-term drift of the focus detection system 50 or the measurement apparatus 100. Therefore, the controller 60 of this embodiment regularly obtains the first offset, but when it is considered that these error factors are non-variable, only the first offset may be obtained.

Thus, the calibration flow ends using the reference plate 42.

Next, the controller 60 detects a measurement position Wp (within the XY plane) of the substrate W in the Z direction using the focus detection system 50 (S1712), and stores a detection value Ow in the memory 62 (S1714). The measurement position Wp is configured to be selected in accordance with a variety of modes, such as one point in the transfer area (shot), all points in the shot, all points of a plurality of shots, and all points of the substrate. Next, the controller 60 measures the measurement position Wp of the substrate W using the measurement apparatus 100 (S1716), and stores a measurement value Pw in the memory 62 (S1718).

Next, the controller 60 calculates the second offset for each measurement position Wp, which is a difference between the measurement value Pw of the measurement apparatus 100 and the detection value Ow of the focus detection system 50, as shown in FIG. 10 (S1720).

Next, the controller 60 stores in the memory 62 a difference between a second offset and a first offset for each measurement position on the substrate (S1722). The offset amount Op is expressed as in an equation below for each measurement position on the substrate W:

Op(i)=[Ow(i)−Pw(i)]−(Om−Pm) EQUATION 1

Here, “i” denotes a number indicative of a measurement position. As the offset amount Op, an average height offset (Z) and an average inclination offset (ωx, ωy) may be stored for each exposure shot (that is a shot for the step-and-repeat method and an exposure slit for the step-and-scan method). Moreover, an offset amount Op may be calculated and stored as an average value for each shot on the substrate.

Thus, the calibration flow of the substrate W ends.

In the scanning exposure, the focus detection system 50 measures a surface position of the measurement position on the substrate W, corrects it using the Equation 1, and measures the surface shape of the substrate. The controller 60 provides focus control based on the corrected substrate shape. This embodiment can improve the focus precision by reducing the measurement errors caused by the reflectance distribution and the local tilt on the substrate, maintains a high resolution and a manufacture yield.

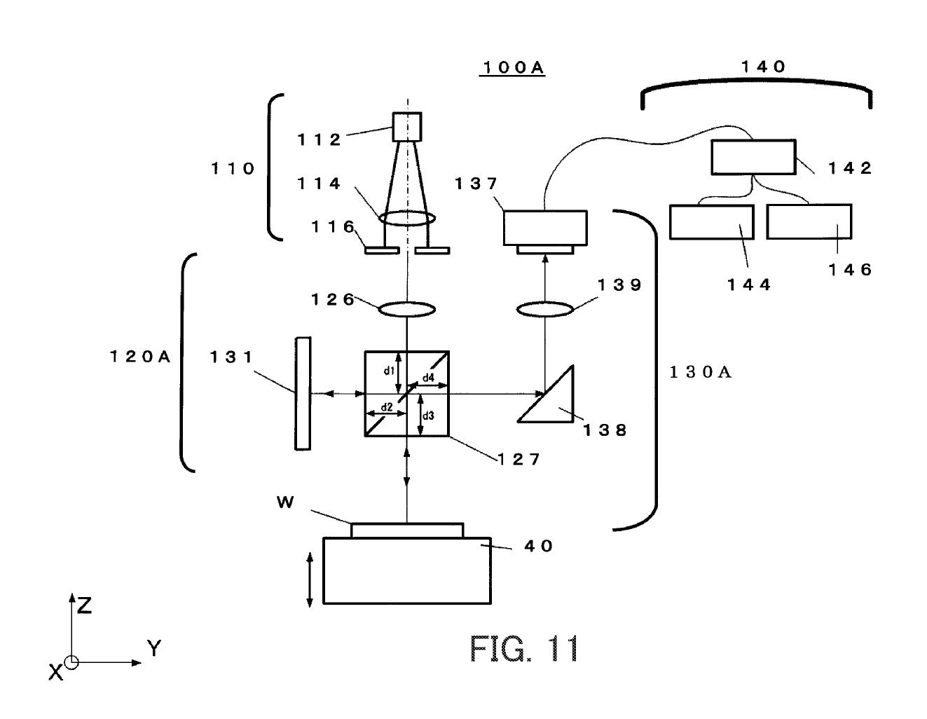

The light projecting optical system 120 and the light receiving optical system 130 may use a normal incidence or refraction optical system instead of an obliquely incident reflection optical system. FIG. 11 is a block diagram of a measurement apparatus 100A that uses a perpendicularly incidence refractive optical system. In FIG. 11, those elements, which are the same reference numerals in FIG. 2, are designated by the same reference numerals.

The light emitted from the light source 112 is condensed by the condenser lens 114 onto the slit plate 116. The light beam that has passed the slit plate 116 passes a lens 126 of a light projecting optical system 120A and enters a beam splitter 127. The measurement light that has passed the beam splitter 127 perpendicularly enters the substrate W, and is reflected on the substrate W. Thereafter, it is reflected on the beam splitter 127 and then a mirror 138 in a light receiving optical system 130A, and detected by the photoelectric conversion element 137 through the lens 139. On the other hand, the reference light that is reflected on the beam splitter 127 perpendicularly enters the reference mirror 131, and then is reflected on the reference mirror 131. Thereafter, the light transmits the beam splitter 127, and then is reflected on the mirror 138, and detected by the photoelectric conversion element 137 via a lens 139.

At this time, the optical path of the reference light in the beam splitter 127 is d1+d2+d2+d4 whereas the optical path of the measurement light in the beam splitter 127 is d1+d3+d3+d4. It is difficult to manufacture the beam splitter 127 so that d2 is made equal to d3. Therefore, a phase difference occurs between the reference light and the measurement light due to the influence of the thickness difference and the optical characteristic (dispersion) of the beam splitter 127, and the white light interference signal distorts, as shown in FIG. 3. In addition, since the reference light and the measurement light are reflected on the different surfaces of the beam splitter 127, the phase changes between the reference light and the measurement light caused by the reflections differ, and the white light interference signal distorts similarly. As pointed out in JP 07-198318, the influence of the adhesion layer of the beam splitter 127 is non-negligible. The number of times the measurement light passes the adhesion layer is different from the number of times the reference light passes, and the white light interference signal also distorts due to the influence of the dispersion of the adhesion layer. Hence, the waveform distortion of the white light interference signal can be reduced by correcting the phase, and the surface position can be highly precisely measured.

A description will now be given of a manufacturing method of a device (such as a semiconductor device and a liquid crystal display device). Here, a manufacturing method of a semiconductor device will be described.

The semiconductor device is manufactured by a pretreatment process of manufacturing an integrated circuit in a wafer, a post-treatment process that completes an integrated circuit chip on the wafer made by the pretreatment process as a product. The pretreatment process includes the step of exposing the photosensitive agent applied substrate using the above exposure apparatus, and the step of developing the substrate. The post-treatment process includes an assembly process (dicing, bonding), and a packaging process (packaging).

The device manufacturing method of this embodiment can provide a higher quality of device than ever.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention can provide a measurement apparatus, a measurement method, a computer, a program, and an exposure apparatus, which can comparatively easily and precisely measure a position of a surface to be measured.

This application claims the benefit of Japanese Patent Application No. 2008-294536, filed Nov. 18, 2008, which is hereby incorporated by reference herein in its entirety.

What is claimed is:

1. A measurement apparatus configured to measure a position of a target surface to be measured, said measurement apparatus comprising:
an interferometer configured to split a broadband light beam from a light source, to guide as measurement light one beam of the broadband light beam to the target surface, to guide as reference light another beam of the broadband light beam to a reference surface, and to detect interference light formed by the measurement light and the reference light by utilizing a photoelectric conversion element; and
a computer configured to calculate a phase distribution and an amplitude distribution by Fourier-transforming a first interference signal detected by the photoelectric conversion element, to correct the phase distribution using a correction-use phase difference distribution, to calculate a second interference signal by reverse-Fourier-transforming the phase distribution that has been corrected and the amplitude distribution, and to calculate the position of the target surface based on the second interference signal.

2. A measurement method configured to measure a position of a target surface to be measured, said measurement method comprising:
an interferometer splitting a broadband light beam from a light source, guiding as measurement light one beam of the broadband light beam to the target surface, guiding as reference light another beam of the broadband light beam to a reference surface, and detecting interference light formed by the measurement light and the reference light by utilizing a photoelectric conversion element;
a computer calculating a phase distribution and an amplitude distribution by Fourier-transforming a first interference signal detected by the photoelectric conversion element;
the computer correcting the phase distribution using a correction-use phase difference distribution;
the computer calculating a second interference signal by reverse-Fourier-transforming the phase distribution that has been corrected and the amplitude distribution; and
the computer calculating the position of the target surface based on the second interference signal.

3. A measurement method according to claim 2, further comprising:
the computer calculating a reference phase distribution by Fourier-transforming an interference signal obtained by a simulation or a measurement;
the computer calculating an error-containing phase distribution by Fourier-transforming an interference signal obtained by an actual measurement utilizing the interferometer and the computer; and
the computer calculating the correction-use phase distribution from a difference between the error-containing phase distribution and the reference phase distribution.

4. A measurement method according to claim 3, wherein the computer calculates the reference phase distribution and the error-containing phase distribution by utilizing an interference signal obtained from the same object to be measured.

5. A computer comprising:
a Fourier transformer configured to calculate a phase distribution and an amplitude distribution by Fourier-transforming a first interference signal detected by a photoelectric conversion element in an interferometer configured to split a broadband light beam from a light source, to guide as measurement light one beam of the broadband light beam to a target surface, to guide as reference light another beam of the broadband light beam to a reference surface, and to detect interference light formed by the measurement light and the reference light by utilizing the photoelectric conversion element;
a corrector configured to correct the phase distribution using a correction-use phase difference distribution;
a reverse Fourier transformer configured to calculate a second interference signal by reverse-Fourier-transforming the phase distribution that has been corrected and the amplitude distribution; and
a calculator configured to calculate a position of the target surface based on the second interference signal.

6. A program that enables a computer to serve as:
a Fourier transformer configured to calculate a phase distribution and an amplitude distribution by Fourier-transforming a first interference signal detected by a photoelectric conversion element in an interferometer configured to split a broadband light beam from a light source, to guide as measurement light one beam of the broadband light beam to a target surface, to guide as reference light another beam of the broadband light beam to a reference surface, and to detect interference light formed by the measurement light and the reference light by utilizing the photoelectric conversion element;
a corrector configured to correct the phase distribution using a correction-use phase difference distribution;
a reverse Fourier transformer configured to calculate a second interference signal by reverse-Fourier-transforming the phase distribution that has been corrected and the amplitude distribution; and
a calculator configured to calculate a position of the target surface based on the second interference signal.

7. An exposure apparatus configured to expose an image of a pattern of an original onto a substrate, said exposure apparatus comprising:
a substrate stage configured to support and drive the substrate;
a measurement apparatus configured to measure a position of a surface of the substrate; and
a controller configured to control driving of the substrate stage based on a measurement result of the measurement apparatus,
wherein the measurement apparatus includes:
an interferometer configured to split a broadband light beam from a light source, to guide as measurement light one beam of the broadband light beam to the surface of the substrate, to guide as reference light another beam of the broadband light beam to a reference surface, and to detect interference light formed by the measurement light and the reference light by utilizing a photoelectric conversion element; and
a computer configured to calculate a phase distribution and an amplitude distribution by Fourier-transforming a first interference signal detected by the photoelectric conversion element, to correct the phase distribution using a correction-use phase difference distribution, to calculate a second interference signal by reverse-Fourier-transforming the phase distribution that has been corrected and the amplitude distribution, and to calculate the position of the surface of the substrate based on the second interference signal.

8. A device manufacturing method comprising the steps of:
exposing a substrate utilizing an exposure apparatus; and
developing the substrate that has been exposed,
wherein the exposure apparatus includes:
a substrate stage configured to support and drive the substrate;
a measurement apparatus configured to measure a position of a surface of the substrate; and
a controller configured to control driving of the substrate stage based on a measurement result of the measurement apparatus,
wherein the measurement apparatus includes:
an interferometer configured to split a broadband light beam from a light source, to guide as measurement light one beam of the broadband light beam to the surface of the substrate, to guide as reference light another beam of the broadband light beam to a reference surface, and to detect interference light formed by the measurement light and the reference light by utilizing a photoelectric conversion element; and
a computer configured to calculate a phase distribution and an amplitude distribution by Fourier-transforming a first interference signal detected by the photoelectric conversion element, to correct the phase distribution using a correction-use phase difference distribution, to calculate a second interference signal by reverse-Fourier-transforming the phase distribution that has been corrected and the amplitude distribution, and to calculate the position of the surface of the substrate based on the second interference signal.
